(19) United States
(12) Patent Application Publication
(10) Pub. No.: US 2010/0001788 A1
(43) Pub. Date: Jan. 7, 2010

(54) SYSTEM TO EVALUATE CHARGE PUMP OUTPUTS AND ASSOCIATED METHODS

(76) Inventors: John E. Barth, JR., Williston, VT (US); John A. Fifield, Underhill, VT (US); Fadi H. Gebara, Austin, TX (US); Jente B. Kuang, Austin, TX (US); Michael Sperling, Poughkeepsie, NY (US)

Correspondence Address: INTERNATIONAL BUSINESS MACHINES CORPORATION;Richard Lau, IPLAW DEPARTMENT / Bldg 008-2, 2455 SOUTH ROAD - MS P386, POUGHKEEPSIE, NY, 12601, US

(21) Appl. No.: 12/168,136

(22) Filed: Jul. 6, 2008

(51) Int. Cl. G05F 3/02; G05F 1/10

(52) U.S. Cl. 327/537

(57) ABSTRACT

A system to evaluate charge pump output may include a comparator to compare a charge pump output voltage to a reference voltage to generate a comparison result. The system may also include a divider to divide down a clock signal. The system may further include a logical conjunction unit to operate on the comparison result and the divided down clock signal.

### FIELD OF THE INVENTION

The invention relates to the field of charge pumps, and, more particularly, to charge pump voltage generators.

### RELATED APPLICATIONS

This application contains subject matter related to the following co-pending applications entitled “Voltage Comparator Apparatus and Method Having Improved Kickback and Jitter Characteristics” and having a U.S. Publication Number of 2008/0042692, “Peak Power Reduction Methods in Distributed Charge Pump Systems” and having an attorney docket number of and AUS820071016, and “System to Monitor Charge Pump Use and Associated Methods” and having an attorney docket number of POU920080091US1, the entire subject matters of which are incorporated herein by reference in their entirety. The aforementioned applications are assigned to the same assignee as this application, International Business Machines Corporation of Armonk, New York.

### BACKGROUND OF THE INVENTION

A charge pump is an electrical circuit that can take in a direct current (“DC”) voltage and generate an output voltage that is higher than the original. An alternate configuration is a negative charge pump which generates a voltage that can be below ground.

A prior art embedded dynamic random access (“eDRAM”) memory cell is illustrated in FIG. 1. During a write to this memory cell, a high voltage is put on the ‘Gate’ 15 and the voltage on the ‘Node’ 11 gets stored by the capacitor 13. The higher the voltage, the faster the capacitor will be charged. A charge pump can be used to generate this high voltage.

During a read of the memory cell, a high voltage is put on the ‘Gate’ 15 and the voltage that is stored on the capacitor 13 can be read at the ‘Node’ 11. The higher the voltage, the faster the read of the memory cell.

During standby, the gate voltage will be driven low to turn off the N-Type transistor 17. Leakage thru this transistor 17 will drain the capacitor. A charge pump can be used to generate this negative voltage to minimize the leakage.

With reference to FIGS. 2-4, in a typical positive charge pump, the positive charge pump will create a new voltage that is higher than the power supply (called VPP). A comparison is usually done to figure out whether the output voltage is high enough. The compare is usually made between some reference voltage and a divided down output voltage.

If the output voltage is too low, the pump can be activated. Looking at FIG. 2, we see P-type 19a-19c and N-type 21 transistors which act as digital switches in FIGS. 3 & 4. A shorted connection refers to the transistor switch being closed while an open connection refers to the transistor switch being open. There are two phases of operation of the charge pump, which are charging and pumping.

During charging as shown in FIG. 3, the power supply voltage VDD appears across the capacitor 23. During pumping as shown in FIG. 4, the charge built up across the capacitor 23 can be discharged into the output VPP. Together with the comparison and reference voltage these components may make up a charge pump system.

As noted above, charge pump voltage generators operate by comparing the output voltage they produce to a reference voltage. For a positive pump, if the output is lower than the reference, a clock signal is activated and charge is pumped to the output. If the output is higher than the reference, no clock is generated. Some of the known solutions for such a comparison system usually involve an analog comparator that is always operating and comparing the two voltages.

In addition, U.S. Pat. No. 5,793,679 to Caser et al. discloses a voltage generator for electrically programmable non-volatile memory cells, constructed of a number of charge pump circuits having inputs controlled by a number of phase generators. The charge pump circuits are laid as pairs of first and second charge pump circuits. The first charge pump circuits are active when the second charge pump circuits are inactive, and vice versa.

### SUMMARY OF THE INVENTION

In view of the foregoing background, it is an object of the invention to evaluate charge pump output based upon a comparison result.

This and other objects, features, and advantages in accordance with the invention are provided by a system to evaluate charge pump output that may include a comparator to compare a charge pump output voltage to a reference voltage to generate a comparison result. The system may also include a divider to divide down a clock signal. The system may further include a logical conjunction unit to operate on the comparison result and the divided down clock signal.

The logical conjunction unit's output may establish the pumping frequency of a charge pump. The logical conjunction unit may comprise an AND gate.

The system may also include a clock to time the comparator and provide the clock signal to the divider. The comparator may generate the comparison result once a clock-cycle. The comparator may retain the comparison result until a next clock-cycle. The comparator, the divider, the logical conjunction unit, and/or the clock may comprise digital components.

The comparator may further include cross-coupled transistors connected to the clock, a preamplifier connected to the cross-coupled transistors. The cross-coupled transistors may provide positive feedback.

Another aspect of the invention is a method of to evaluate charge pump output. The method may include comparing a charge pump output voltage to a reference voltage to generate a comparison result. The method may also include dividing down a clock signal. The method may further include performing a logical conjunction on the comparison result and the divided down clock signal.

The method may further include establishing the pumping frequency of a charge pump based upon the comparison result. The method may additionally include performing the comparison once a clock-cycle.

The method may also include retaining the comparison result until a next clock-cycle. The method may further include electrically disconnecting any inputs during the comparison.

### BRIEF DESCRIPTION OF THE DRAWINGS

FIG. 1 is a schematic block diagram of a prior art eDRAM charge pump.

FIG. 2 is a schematic block diagram of a prior art positive charge pump.

FIG. 3 is a schematic block diagram of the prior art positive charge pump of FIG. 2 charging.

FIG. 4 is a schematic block diagram of the prior art positive charge pump of FIG. 2 pumping.

FIG. 5 is a schematic block diagram of a system to evaluate charge pump output in accordance with the invention.

FIG. 6 is a schematic block diagram of one possible embodiment of the comparator from FIG. 5.

FIG. 7 is a flowchart illustrating method aspects according to the invention.

FIG. 8 is a flowchart illustrating method aspects according to the method of FIG. 7.

FIG. 9 is a flowchart illustrating method aspects according to the method of FIG. 7.

FIG. 10 is a flowchart illustrating method aspects according to the method of FIG. 7.

FIG. 11 is a flowchart illustrating method aspects according to the method of FIG. 7.

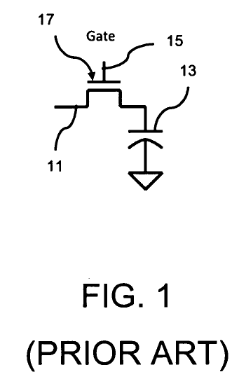

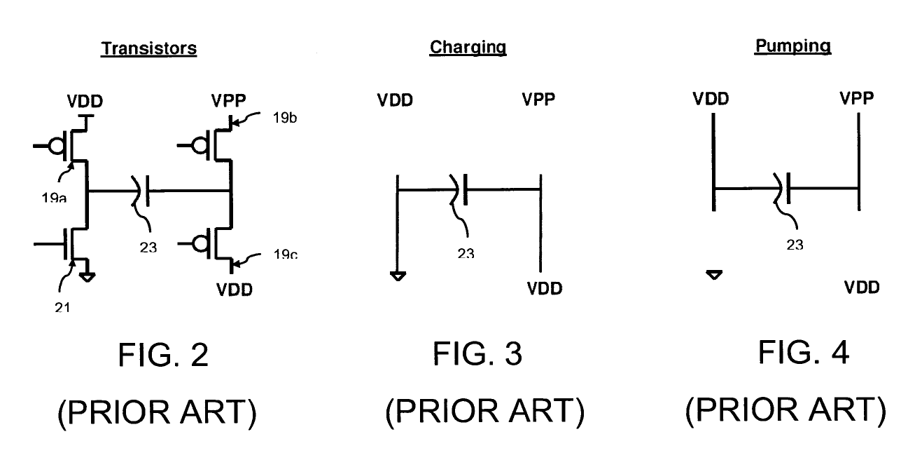

### DETAILED DESCRIPTION OF THE PREFERRED EMBODIMENTS

The invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As will be appreciated by one skilled in the art, the invention may be embodied as a method, system, or computer program product. Furthermore, the invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device.

Computer program code for carrying out operations of the invention may be written in an object oriented programming language such as Java, Smalltalk, C++ or the like. However, the computer program code for carrying out operations of the invention may also be written in conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

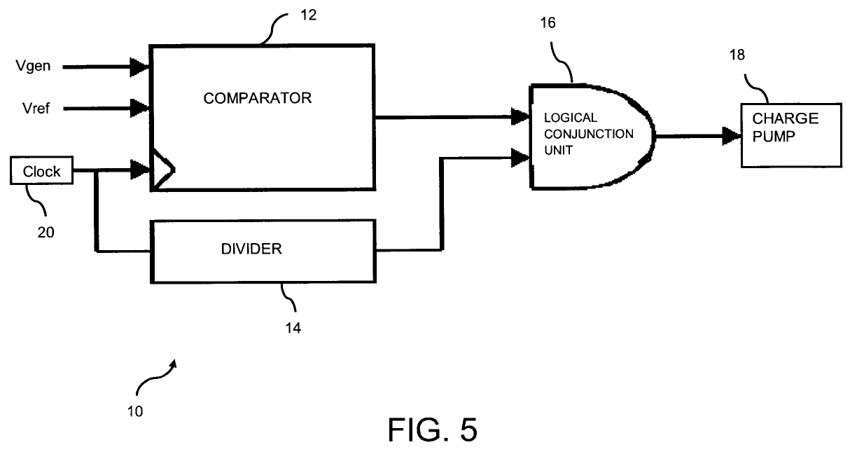

Referring to FIG. 5, a system 10 to evaluate charge pump output includes a comparator 12 to compare a charge pump output voltage to a reference voltage to generate a comparison result, for example. The system 10 also includes a divider 14 to divide down a clock signal, for instance.

The system 10 further includes a logical conjunction unit 16 to operate on the comparison result and the divided down clock signal, for example. The comparator 12, the divider 14, and/or the logical conjunction unit 16 comprise software, firmware, hardware, or some combination thereof as will be appreciated by those of skill in the art.

In one embodiment, the logical conjunction unit 16's output establishes the pumping frequency of a charge pump 18. In another embodiment, the logical conjunction unit 16 comprises an AND gate.

The system 10 also includes a clock 20 to set and/or control the timing of the comparator 12, and to provide the clock signal to the divider 14, for example. The comparator 12 generates the comparison result once a clock-cycle. Stated another way, the comparator 12 is a clocked comparator as will be appreciated by those of skill in the art.

In one embodiment, the comparator 12 retains the comparison result until a next, e.g. subsequent, clock-cycle. In another embodiment, the comparator 12, the divider 14, the logical conjunction unit 16, and/or the clock comprise digital components.

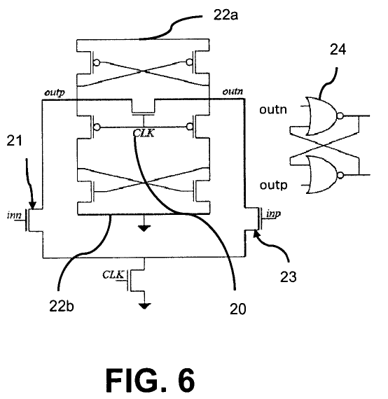

With reference to FIGS. 6, the comparator 12 further includes cross-coupled transistors 22a and 22b connected to the clock 20, a preamplifier, e.g. the two transistors 21 and 23 that are labeled inn & inp in FIG. 6, and set-reset logic gates 24 connected to the cross-coupled transistors, for example. The set-reset logic gates 24 hold the signal for the duration of the clock-cycle, for instance. The cross-coupled transistors 22a and 22b provide positive feedback, for example.

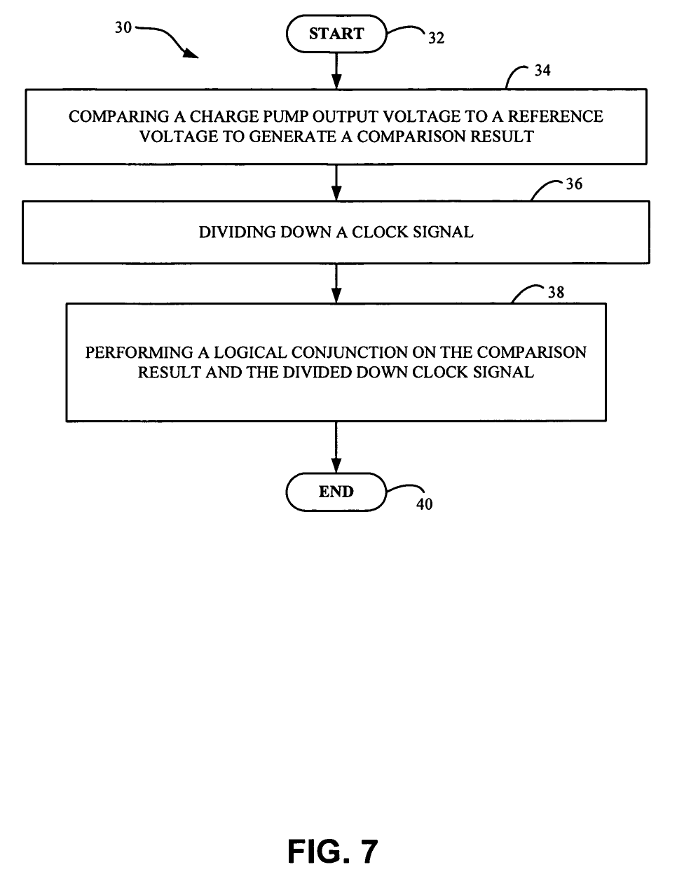

Another aspect of the invention is a method to evaluate charge pump output, which is now described with reference to flowchart 30 of FIG. 7. The method begins at Block 32 and may include comparing a charge pump output voltage to a reference voltage to generate a comparison result at Block 34. The method may also include dividing down a clock signal at Block 36. The method may further include performing a logical conjunction on the comparison result and the divided down clock signal at Block 38. The method ends at Block 40.

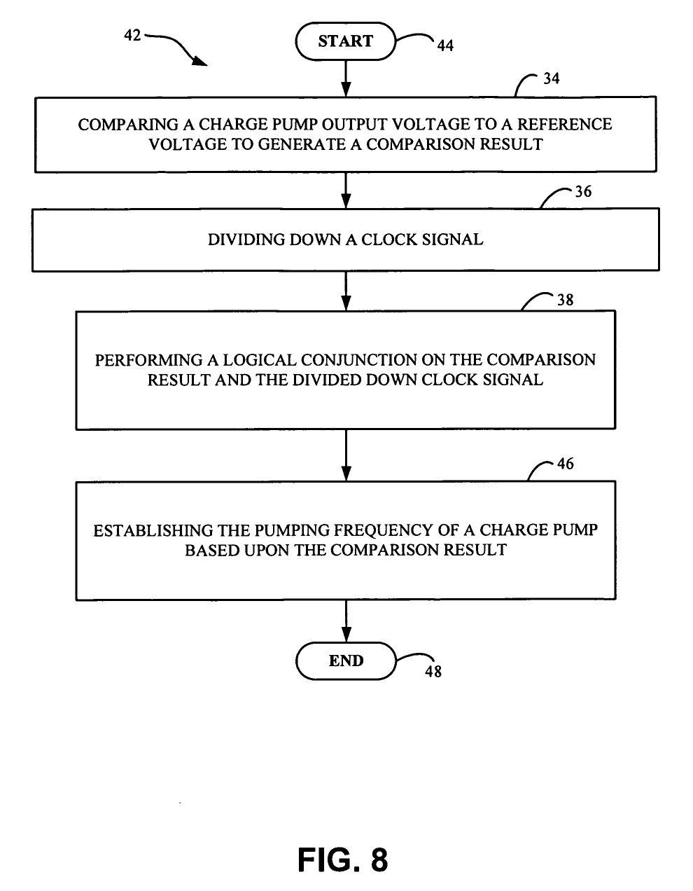

In another method embodiment, which is now described with reference to flowchart 42 of FIG. 8, the method begins at Block 44. The method may include the steps of FIG. 7 at Blocks 34, 36, and 38. The method may also include establishing the pumping frequency of a charge pump based upon the comparison result at Block 46. The method ends at Block 48.

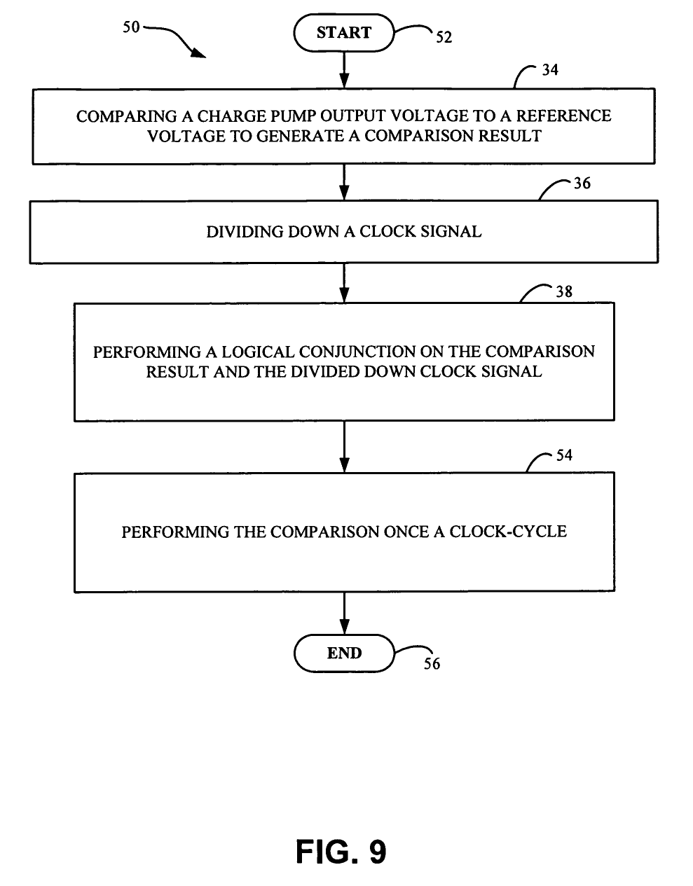

In another method embodiment, which is now described with reference to flowchart 50 of FIG. 9, the method begins at Block 52. The method may include the steps of FIG. 7 at Blocks 34, 36, and 38. The method may further include performing the comparison once a clock-cycle at Block 54. The method ends at Block 56.

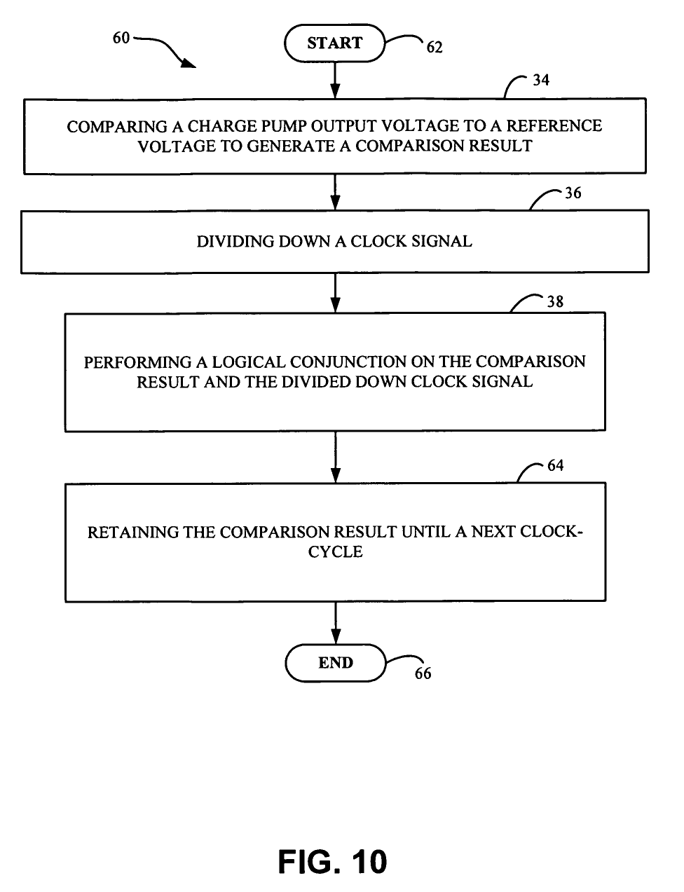

In another method embodiment, which is now described with reference to flowchart 60 of FIG. 10, the method begins at Block 62. The method may include the steps of FIG. 7 at Blocks 34, 36, and 38. The method may further include retaining the comparison result until a next clock-cycle at Block 64. The method ends at Block 66.

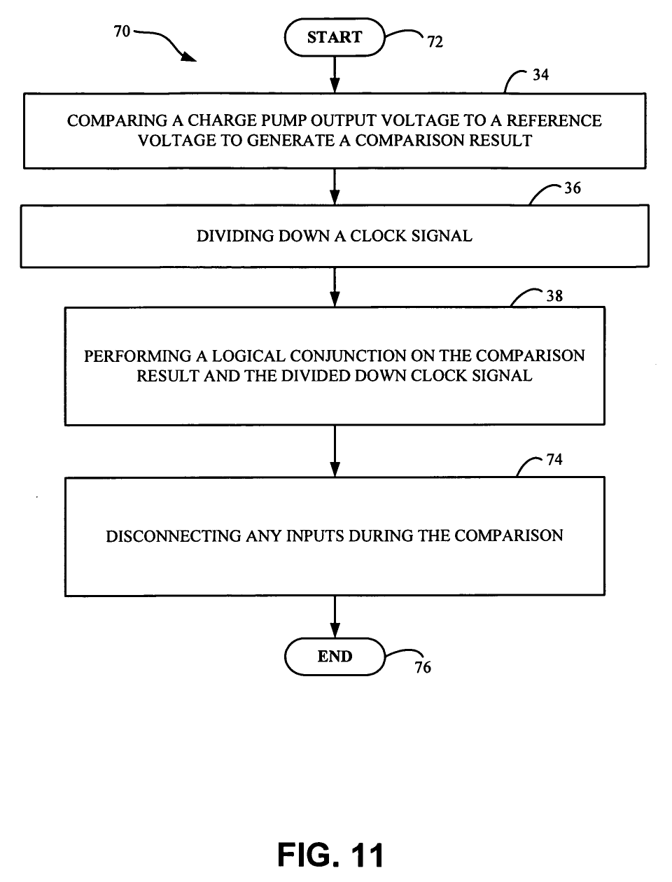

In another method embodiment, which is now described with reference to flowchart 70 of FIG. 11, the method begins at Block 72. The method may include the steps of FIG. 7 at Blocks 34, 36, and 38. The method may further include electrically disconnecting any inputs during the comparison at Block 74. The method ends at Block 76.

In view of the foregoing, the system 10 evaluates a charge pump output thus providing more accurate comparisons, lower power (only uses power during clock transitions) and more migratability to different semi-conductor processes. In contrast, known solutions for such a comparison system mostly involve an analog comparator, which is always operating and comparing the two voltages. This has the drawback of drawing current all the time as well as introducing additional time constants to the charge pump loop.

Referring back to FIG. 5, one prophetic example of the system 10 is now described. In this embodiment, a high-speed clock signal, e.g. from clock 20, is sent to a digital comparator, e.g. comparator 12, that compares a generated voltage (or a divided down generated voltage) and a reference voltage. The compare is made once a cycle and the result is then held until the next cycle. This result is ANDed, e.g. in logical conjunction unit 16, with a divided down clock, e.g. provided by divider 14, in order to set the pumping frequency of the voltage generator, e.g. charge pump 18.

Referring back to FIG. 6, another prophetic example of the system 10 is now described. In this embodiment, a clocked digital comparator, e.g. comparator 12, uses cross-coupled transistors 22a and 22b, a pre-amplifier, e.g. the two transistors 21 and 23, and set-reset logic 24. This reduces the offset, resulting in better accuracy and lower power when the clock 20 turns off. The coupling from clock 20 to input is also reduced since the inputs are electrically disconnected during the compare phase of the clock. The clocked digital comparators with cross-coupled transistors provide positive feedback and are used instead of an analog comparator.

The capabilities of the system 10 can be implemented in software, firmware, hardware or some combination thereof.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention. Furthermore, the use of the terms a, an, etc. do not denote a limitation of quantity, but rather denote the presence of at least one of the referenced item.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

That which is claimed is:

1. A system to evaluate charge pump output, the system comprising:
a comparator to compare a charge pump output voltage to a reference voltage to generate a comparison result;
a divider to divide down a clock signal; and
a logical conjunction unit to operate on the comparison result and the divided down clock signal.

2. The system of claim 1 wherein said logical conjunction unit's output establishes the pumping frequency of a charge pump.

3. The system of claim 1 wherein said logical conjunction unit comprises an AND gate.

4. The system of claim 1 further comprising a clock to time said comparator and provide the clock signal to said divider.

5. The system of claim 4 wherein said comparator generates the comparison result once a clock-cycle.

6. The system of claim 5 wherein said comparator retains the comparison result until a next clock-cycle.

7. The system of claim 4 wherein at least one of said comparator, said divider, said logical conjunction unit, and said clock comprise digital components.

8. The system of claim 4 further comprising:
cross-coupled transistors connected to said clock; and
a preamplifier connected to said cross-coupled transistors.

9. The system of claim 8 wherein said cross-coupled transistors provide positive feedback.

10. A method to evaluate charge pump output, the method comprising:
comparing a charge pump output voltage to a reference voltage to generate a comparison result;
dividing down a clock signal; and
performing a logical conjunction on the comparison result and the divided down clock signal.

11. The method of claim 10 further comprising establishing the pumping frequency of a charge pump based upon the comparison result.

12. The method of claim 10 further comprising performing the comparison once a clock-cycle.

13. The method of claim 10 further comprising retaining the comparison result until a next clock-cycle.

14. The method of claim 10 further comprising electrically disconnecting any inputs during the comparison.

15. A system to evaluate charge pump output, the system comprising:
a comparator to compare a charge pump output voltage to a reference voltage to generate a comparison result once a clock-cycle;
a clock to time said comparator and provide a clock signal;
a divider to divide down the clock signal; and
a logical conjunction unit to operate on the comparison result and the divided down clock signal.

16. The system of claim 15 wherein said logical conjunction unit's output establishes a charge pump pumping frequency.

17. The system of claim 15 wherein said logical conjunction unit comprises an AND gate.

18. The system of claim 15 wherein said comparator retains the comparison result until a next clock-cycle.

19. The system of claim 15 further comprising:
cross-coupled transistors connected to said clock; and
a preamplifier connected to said cross-coupled transistors.

20. The system of claim 19 wherein said cross-coupled transistors provide positive feedback.
